(19) United States
(12) Patent Application Publication
(10) Pub. No.: US 2026/0188942 A1
(43) Pub. Date: Jul. 2, 2026

(54) DC SOCKET

(71) Applicant: Schneider Electric Industries SAS, Rueil-Malmaison (FR)

(72) Inventors: Dahai Zhang, Nanshan District Shenzhen (CN); Jingyi Liu, Nanshan District Shenzhen (CN); Xinyu Li, Nanshan District Shenzhen (CN); QiLian Du, Nanshan District Shenzhen (CN); Youliang Zhang, Nanshan District Shenzhen (CN); Yun Li, Nanshan District Shenzhen (CN); Zhen Ma, Nanshan District Shenzhen (CN)

(21) Appl. No.: 19/435,050

(22) Filed: Dec. 29, 2025

(30) Foreign Application Priority Data
Dec. 30, 2024 (CN) 202411975313.9

(51) Int. Cl. H01R 13/53

(52) U.S. Cl. CPC H01R 13/53

(57) ABSTRACT

A DC socket includes: a base including a receiving groove, and a pair of fixed attracting members and a pair of electrode socket contacts disposed in the receiving groove; a first connecting member, an end of the first connecting member being electrically connected to one electrode socket contact, and the other end of the first connecting member being provided with a moving contact point; a moving member adapted to be pressed or released by a pin to move along a moving direction; a mating member movably connected to the moving member and adapted to move along the moving direction and coupled to the first connecting member; and a movable attracting member disposed on the mating member and located between the pair of fixed attracting members. The movable attracting member can move towards a corresponding fixed attracting member upon being adjacent to the corresponding fixed attracting member.

### RELATED APPLICATION

This application claims priority to Chinese Patent Application No. 202411975313 filed on Dec. 30, 2024, and entitled “DC SOCKET”, the entirety of which is incorporated herein by reference.

### TECHNICAL FIELD

Implementations of the present disclosure generally relate to the technical field of electrical equipment, and more particularly, to a DC socket.

### BACKGROUND

A DC socket is an electrical socket adapted to be connected to a DC power source. Since the direct current (DC) does not exhibit periodic variation, that is, the DC has no zero-crossing point, an arc between the plug and the socket has a long combustion duration during the process of pulling out the plug, thereby damaging the socket. Therefore, how to rapidly extinguish the arc is an urgent technical problem that needs to be solved currently for the DC socket.

### SUMMARY

In a first aspect of the present disclosure, a DC socket is provided. The DC socket is adapted to mate with a plug and includes: a base including a receiving groove, and a pair of fixed attracting members and a pair of electrode socket contacts disposed in the receiving groove; a top cover covering the receiving groove; a first connecting member disposed in the receiving groove, where an end of the first connecting member is electrically connected to one electrode socket contact of the pair of electrode socket contacts, and the other end of the first connecting member is provided with a moving contact point; a moving member disposed in the receiving groove and adapted to be pressed or released by at least one pin of the plug to move along a moving direction; a mating member disposed in the receiving groove and movably connected to the moving member, the mating member being adapted to move along the moving direction and coupled to the first connecting member; and a movable attracting member disposed on the mating member and located between the pair of fixed attracting members in the moving direction, where the movable attracting member is adapted to move towards a corresponding fixed attracting member under the action of an attractive force upon being adjacent to the corresponding fixed attracting member of the pair of fixed attracting members.

In some implementations, the DC socket further includes a second connecting member and an arc guide member that are disposed in the receiving groove, the second connecting member includes a fixed contact point mated with the moving contact point, and the arc guide member is disposed adjacent to the moving contact point and the fixed contact point.

In some implementations, the magnetism of a side of the arc guide member adjacent to the top cover is opposite to the magnetism of a side of the arc guide member facing away from the top cover.

In some implementations, the moving member includes a first main body including a driving surface, the base further includes a ground socket contact disposed in the receiving groove, the driving surface is located at a side of the ground socket contact facing away from the top cover and is spaced apart from the ground socket contact, and the driving surface is obliquely arranged relative to an insertion direction of a ground pin of the plug.

In some implementations, a side of the first main body adjacent to the top cover is provided with a mating groove, and a portion of the mating member is disposed in the mating groove and is adapted to move relative to the mating groove.

In some implementations, the base includes a limiting member disposed in the receiving groove, the moving member further includes a protrusion and an elastic member, the protrusion is disposed on a side of the first main body facing away from the top cover, an end of the elastic member is connected to a side of the protrusion facing away from the driving surface, and the other end of the elastic member is connected to the limiting member.

In some implementations, the fixed attracting part includes a metal member, the movable attracting member is located in the mating groove and includes a magnetic body and a pair of magnetic conductive parts, one magnetic conductive part of the pair of magnetic conductive parts is disposed on a side of the magnetic body adjacent to the top cover, the other magnetic conductive part of the pair of magnetic conductive parts is disposed on a side of the magnetic body facing away from the top cover, and the pair of magnetic conductive parts are adapted to be magnetized by the magnetic body.

In some implementations, the moving member further includes a pair of transmission parts arranged on the side of the first main body adjacent to the top cover at an interval along the moving direction, the mating member includes a second main body, a portion of the second main body is disposed in the mating groove and includes a pair of connecting grooves and a pair of elastic parts, each elastic part of the pair of elastic parts is disposed in the corresponding connecting groove, and an end of each elastic part of the pair of elastic parts protruding from the corresponding connecting groove is adapted to abut against the corresponding transmission part.

In some implementations, each elastic part includes a spring.

In some implementations, the mating member further includes a third main body, the third main body is disposed on a side of the second main body facing away from the driving surface and includes a mounting hole, and a transmission part of the pair of transmission parts that faces away from the driving surface is located in the mounting hole and is movable within the mounting hole.

In some implementations, a mounting groove is disposed on a side of the first main body facing away from the top cover, the mounting groove is in communication with the mating groove and is adjacent to the driving surface, and a fixed attracting member of the pair of fixed attracting members that is adjacent to the driving surface is located in the mounting groove and the mating groove.

In some implementations, the third main body includes a clamping hole and a pair of clamping parts, the pair of clamping parts are disposed in the clamping hole along the moving direction, and the first connecting member passes through the clamping hole and is clamped by the pair of clamping parts.

In some implementations, the clamping hole and the pair of clamping parts are located at an end of the third main body facing away from the second main body.

In some implementations, the first connecting member includes an elastic sheet arranged in a bent shape.

It should be understood that the content described in this section is not intended to limit the key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various implementations of the present disclosure will become more apparent from the following detailed description taken in conjunction with the accompanying drawings. In the drawings, the same or similar reference numbers refer to the same or similar elements, where:

FIG. 1 shows a schematic structural diagram of a plug and a DC socket according to some implementations of the present disclosure;

FIG. 2 shows a structural schematic diagram of a portion of a DC socket according to some implementations of the present disclosure;

FIG. 3 shows a structural schematic diagram of a portion of a DC socket according to some implementations of the present disclosure;

FIG. 4 shows a structural schematic diagram of a moving member, a mating member, a movable attracting member, and a pair of fixed attracting members according to some implementations of the present disclosure;

FIG. 5 shows a structural schematic diagram of a moving member, a mating member, and a movable attracting member according to some implementations of the present disclosure;

FIG. 6 shows a cross-sectional view of a moving member, a mating member, a movable attracting member, a first connecting member, and a pair of fixed attracting members according to some implementations of the present disclosure;

FIGS. 7 to 16 show schematic workflow diagrams of a DC socket according to some implementations of the present disclosure.

### DETAILED DESCRIPTION

Implementations of the present disclosure will be described in more detail below with reference to the accompanying drawings. While implementations of the present disclosure are shown in the drawings, it should be understood that the present disclosure may be implemented in various forms and should not be limited by implementations set forth herein. Rather, these implementations are provided to make this disclosure more thorough and complete, and to fully convey the scope of the present disclosure to those skilled in the art.

As used herein, the term “including” and variations thereof represent openness, i.e., “including but not limited to”. Unless specifically stated, the term “or” means “and/or”. The term “based on” means “based at least in part on”. The terms “an example implementation” and “an implementation” mean “at least one example implementation”. The term “another implementation” means “at least one further implementation”. The terms “first”, “second”, and the like may refer to different or identical objects.

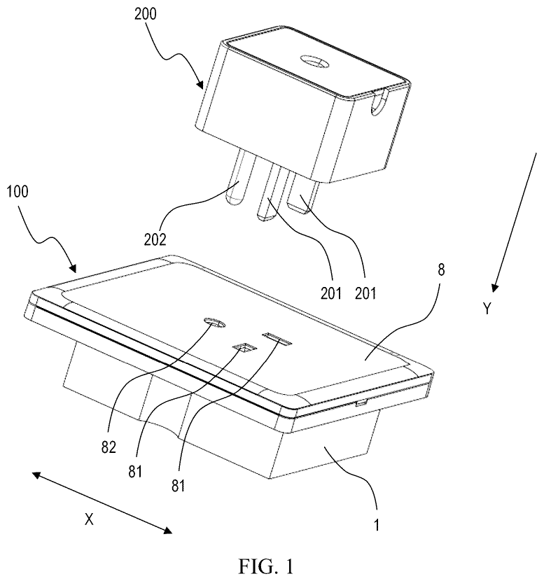

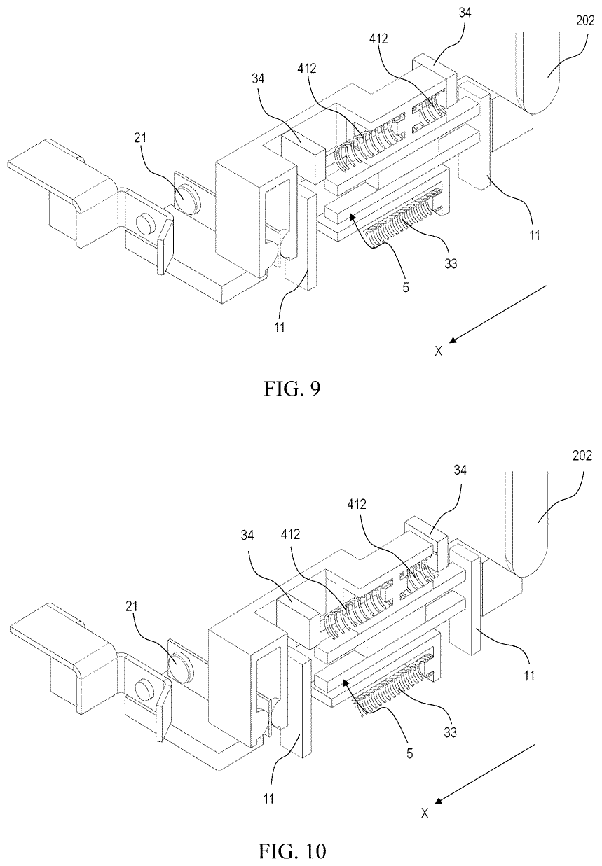

As described above, since the direct current (DC) does not exhibit periodic variation, that is, the DC has no zero-crossing point, an arc between the plug and the socket has a long combustion duration during the process of pulling out the plug, thereby damaging the socket. Therefore, how to rapidly extinguish the arc is an urgent technical problem that needs to be solved currently for the DC socket. Implementations of the present disclosure provide a DC socket 100 to at least partially solve the above problems. Hereinafter, the principles of the present disclosure will be described with reference to FIGS. 1 to 16.

The present disclosure includes the following reference numerals: 100 DC socket; 101 receiving groove; 200 plug; 201 electrode pin; 202 ground pin; 1 base; 11 fixed attracting member; 12 electrode socket contact; 13 ground socket contact; 14 limiting member; 15 first mounting member; 16 second mounting member; 17 electrode terminal; 18 ground terminal; 2 first connecting member; 21 moving contact point; 3 moving member; 31 first main body; 311 driving surface; 312 mating groove; 313 mounting groove; 32 protrusion; 33 elastic member; 34 transmission part; 4 mating member; 41 second main body; 411 connecting groove; 412 elastic part; 42 third main body; 421 mounting hole; 422 clamping hole; 423 clamping part; 5 movable attracting member; 51 magnetic body; 52 magnetic conductive part; 6 second connecting member; 61 fixed contact point; 7 arc guide member; 8 top cover; 81 electrode hole; 82 ground hole; X moving direction; Y insertion direction of ground pin.

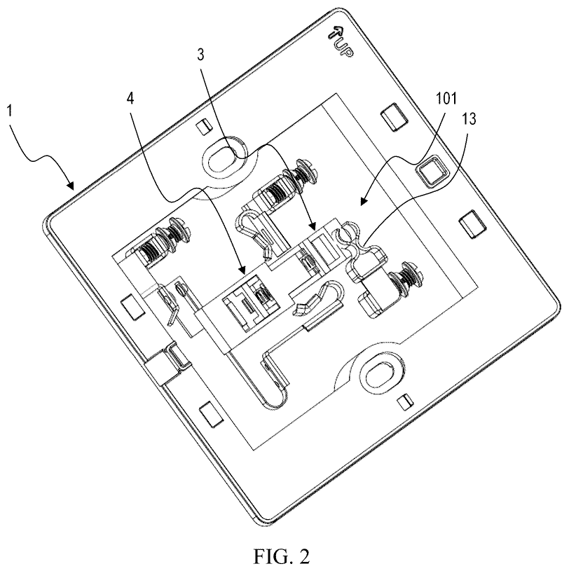

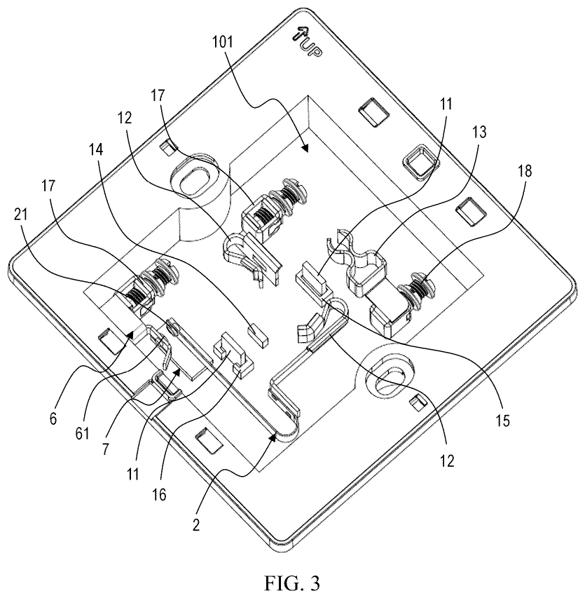

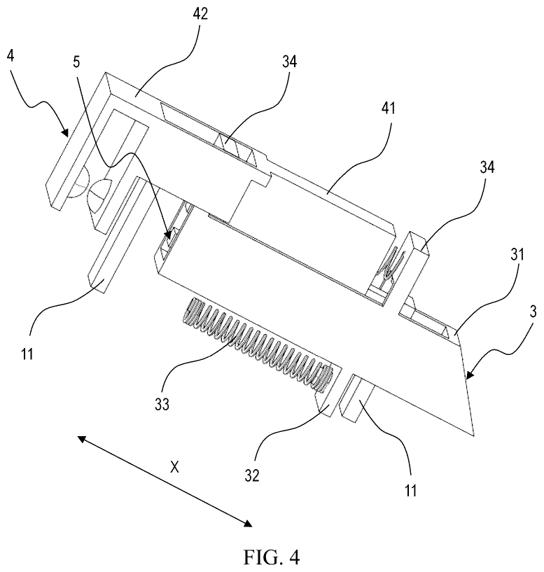

FIG. 1 shows a schematic structural diagram of a plug 200 and a DC socket 100 according to some implementations of the present disclosure. FIG. 2 shows a structural schematic diagram of a portion of the DC socket 100 according to some implementations of the present disclosure. FIG. 3 shows a structural schematic diagram of a portion of the DC socket 100 according to some implementations of the present disclosure. FIG. 4 shows a structural schematic diagram of a moving member 3, a mating member 4, a movable attracting member 5, and a pair of fixed attracting members 11 according to some implementations of the present disclosure. As shown in FIGS. 1 to 4, the DC socket 100 described herein is adapted to mate with the plug 200, and the DC socket 100 generally includes a base 1, a first connecting member 2, the moving member 3, the mating member 4, the movable attracting member 5, a second connecting member 6, an arc guide member 7, and a top cover 8.

Referring to FIGS. 1 and 2, in some implementations, the base 1 includes a receiving groove 101, the fixed attracting members 11, a pair of electrode socket contacts 12, a ground socket contact 13, a limiting member 14, a first mounting member 15, a second mounting member 16, a pair of electrode terminals 17, and a ground terminal 18. The receiving groove 101 may be configured to receive internal components of the DC socket 100, such as the fixed attracting members 11, the pair of electrode socket contacts 12, the ground socket contact 13, the limiting member 14, the first mounting member 15, the second mounting member 16, the pair of electrode terminals 17, the ground terminal 18, the first connecting member 2, the moving member 3, the mating member 4, the movable attracting member 5, the second connecting member 6, and the arc guide member 7.

With continued reference to FIGS. 1 to 3, in some implementations, the top cover 8 may cover the receiving groove 101 to protect the internal components in the receiving groove 101. The top cover 8 may be provided with a ground hole 82 and a pair of electrode holes 81. Therefore, the pair of electrode pins 201 of the plug 200 may be each inserted into the corresponding electrode hole 81 and be mated with the corresponding electrode socket contact 12. The ground pin 202 of the plug 200 may be inserted into the ground hole 82 and be mated with the ground socket contact 13, and the ground socket contact 13 may be connected to the ground terminal 18.

With continued reference to FIG. 3, in order to fixedly dispose the pair of fixed attracting members 11 in the base 1, in some implementations, one fixed attracting member 11 of the pair of fixed attracting members 11 may be inserted into the first mounting member 15, and the other fixed attracting member 11 of the pair of fixed attracting members 11 may be inserted into the second mounting member 16. It should be understood that, in other implementations, the pair of fixed attracting members 11 may be assembled in the receiving groove 101 by any other suitable connection methods.

With continued reference to FIGS. 2 to 4, in some implementations, an end of the first connecting member 2 is electrically connected to one electrode socket contact 12 of the pair of electrode socket contacts 12, and the other end of the first connecting member 2 is provided with a moving contact point 21. The moving member 3 can be pressed or released by at least one pin of the plug 200 to move along a moving direction X, such as by the ground pin 202. The mating member 4 is movably connected to the moving member 3, so that the mating member 4 can move along the moving direction X under the driving of the moving member 3. The mating member 4 is coupled to the first connecting member 2, so that the first connecting member 2 can move along with the mating member 4 when the mating member 4 moves. The movable attracting member 5 is disposed on the mating member 4 and is located between the pair of fixed attracting members 11 in the moving direction X, and the movable attracting member 5 and the fixed attracting members 11 may attract each other. Thus, the movable attracting member 5 is able to move towards a corresponding fixed attracting member 11 under the action of an attractive force upon being adjacent to the corresponding fixed attracting members 11 of the pair of fixed attracting members 11.

According to implementations of the present disclosure, during the process of pulling out the plug 200, the moving member 3 can be released by at least one pin and thus move, and the mating member 4 and the movable attracting member 5 can move towards one fixed attracting member 11 of the pair of fixed attracting members 11. Upon a distance between the movable attracting member 5 and the fixed attracting member 11 being reduced to an appropriate distance, the movable attracting member 5 can be attracted by the fixed attracting member 11 under the action of attracting force and thus move rapidly, so that the whole of the movable attracting member 5 and the mating member 4 moves rapidly and drives the moving contact point 21 on the first connecting member 2 to be rapidly disconnected from a fixed contact point, thereby achieving the purpose of rapid arc extinguishing.

It should be noted that, referring to FIG. 3, the second connecting member 6 is electrically connected to one electrode terminal 17 of the pair of electrode terminals 17, and the second connecting member 6 includes a fixed contact point 61 that is mated with the moving contact point 21. In addition, the other electrode terminal 17 is electrically connected to the corresponding electrode socket contact 12. It can be understood that, in a case where the moving contact point 21 is electrically connected to the fixed contact point 61, the corresponding electrode terminal 17, the second connecting member 6, the first connecting member 2, and the corresponding electrode socket contact 12 form a conductive circuit, and the plug 200 can draw power from the DC socket. In a case where the movable attracting member 5 is attracted by one of the fixed attracting members 11 during the process of pulling out the plug 200, the moving contact point 21 on the first connecting member 2 moves rapidly away from the fixed contact point 61 to rapidly extinguish the arc between the moving contact point 21 and the fixed contact point 61. In some implementations, the electrode terminal 17 electrically connected to the second connecting member 6 may include a positive electrode terminal, and correspondingly, the first connecting member 2 is electrically connected to the positive electrode socket contact. Of course, in other implementations, the electrode terminal 17 electrically connected to the second connecting member 6 may include a negative electrode terminal, and correspondingly, the first connecting member 2 is electrically connected to the negative electrode socket contact. In addition, referring to FIG. 2, the first connecting member 2 may include an elastic sheet, and the elastic sheet may be arranged in a bent shape. Thus, in a case where the mating member 4 drives the elastic sheet to move, the elastic sheet can rotate around its bending position and tends to undergo deformation.

With continued reference to FIG. 3, further, the arc guide member 7 may be disposed adjacent to the moving contact point 21 and the fixed contact point 61, and the arc guide member 7 is further away from the top cover 8 than the moving contact point 21 and the fixed contact point 61. Thus, the arc guide member 7 can guide the movement of the arc between the moving contact point 21 and the fixed contact point 61 to serve the function of arc extinguishing. For example, the magnetism of a side of the arc guide member 7 adjacent to the top cover 8 is opposite to the magnetism of a side of the arc guide member 7 facing away from the top cover 8. Thus, in a case where an arc is generated between the moving contact point 21 and the fixed contact point 61, the arc guide member 7 can elongate the arc in a direction towards one of the electrode socket contacts 12 so as to quickly extinguish the arc.

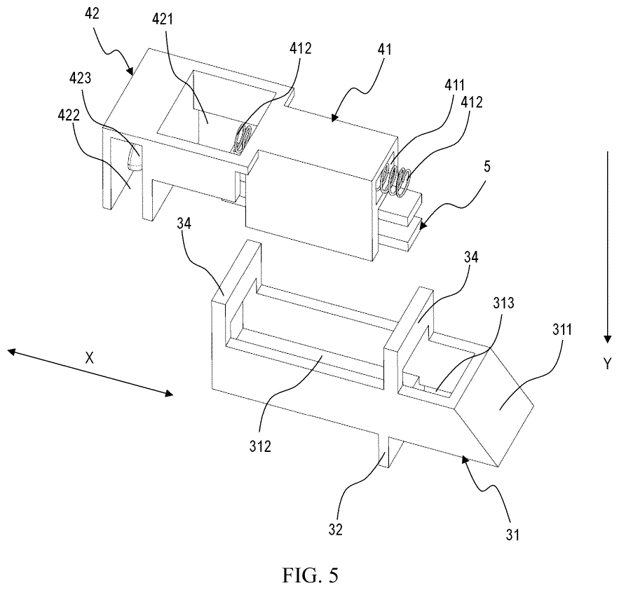

FIG. 5 shows a structural schematic diagram of the moving member 3, the mating member 4, and the movable attracting member 5 according to some implementations of the present disclosure. As shown in FIGS. 1, 2 and 5, in some implementations, the moving member 3 may include a first main body 31, and the first main body 31 includes a driving surface 311. The drive surface 311 may be disposed obliquely with respect to an insertion direction Y of the ground pin 202 of the plug 200. Thus, upon the driving surface 311 being driven by the ground pin 202, the moving member 3 can move along the moving direction X.

Further, referring to FIGS. 1 to 3 and 5, the driving surface 311 may be located at a side of the ground socket contact 13 facing away from the top cover 8 and be spaced apart from the ground socket contact 13. That is, the driving surface 311 is farther away from the top cover 8 than the ground socket contact 13. Therefore, during the process of pulling out the plug 200, the ground pin 202 is first separated from the driving surface 311. Since the moving member 3 has been reset when the ground pin 202 is separated from the driving surface 311, the moving contact point 21 has been separated from the fixed contact point 61, and the electrode socket contact 12 is not energized at this point. The ground pin 202 is then separated from the ground socket contact 13 while the pair of electrode pins 201 are separated from the corresponding electrode socket contacts 12. Since the electrode socket contacts 12 are not energized, the electrode pins 201 and the electrode socket contacts 12 may be separated in a non-energized state, thereby avoiding the generation of arcs between the electrode pins 201 and the electrode socket contacts 12.

In addition, in the DC socket 100 according to implementations of the present disclosure, the arc is generated between the moving contact point 21 and the fixed contact point 61 compared with a scheme in which the arcs are generated between the electrode pins 201 and the electrode socket contacts 12, the generated arc is located in the base 1 and is isolated in implementations of the present disclosure, thereby effectively avoiding electric shock accidents. In addition, during the process of pulling out the plug 200, when the moving contact point 21 and the fixed contact point 61 are just separated from each other, an insulating part of the electrode pin 201 is still located in the corresponding electrode hole 81, and a conductive part of the electrode pin 201 is also located in the corresponding electrode hole 81, so as to prevent the operator from touching the conductive part of the electrode pin 201. With the plug 200 being pulled out further, the conductive part of the electrode pin 201 gradually exposes out of the electrode hole 81, however, since the moving contact point 21 has been separated from the fixed contact point 61, the electrode pin 201 is not energized, thereby effectively avoiding electric shock accidents.

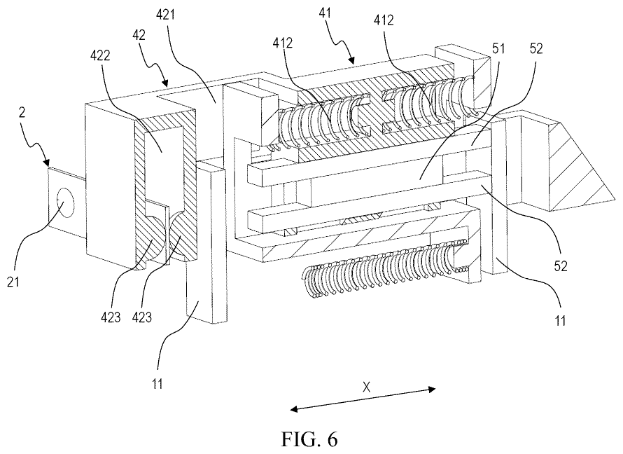

FIG. 6 shows a cross-sectional view of the moving member 3, the mating member 4, the movable attracting member 5, the first connecting member 2, and the pair of fixed attracting members 11 according to some implementations of the present disclosure. As shown in FIGS. 4 to 6, in some implementations, a side of the first main body 31 adjacent to the top cover 8 is provided with a mating groove 312, and a portion of the mating member 4 is disposed in the mating groove 312 and is adapted to move relative to the mating groove 312. In addition, the movable attracting member 5 may also be located in the mating groove 312 and can move relative to the mating groove 312 under the driving of the mating member 4. In this way, the mating member 4 and the movable attracting member 5 are both located in the mating groove 312 and can move in the mating groove 312, so that the size of the whole of the moving member 3, the mating member 4, and the movable attracting member 5 can be reduced on the basis of satisfying the mutual mating among the moving member 3, the mating member 4, and the movable attracting member 5, thereby improving the structural compactness of the DC socket 100.

In some implementations, referring back to FIG. 3, the base 1 further includes a limiting member 14 disposed in the receiving groove 101. Referring to FIGS. 4 to 6, the moving member 3 further includes a protrusion 32 and an elastic member 33. The protrusion 32 may be disposed on a side of the first main body 31 facing away from the top cover 8. An end of the elastic member 33 is connected to a side of the protrusion 32 facing away from the driving surface 311, and the other end of the elastic member 33 is connected to the limiting member 14. It can be understood that, in a case where the ground pin 202 drives the moving member 3 to move along the moving direction X, the elastic member 33 can be compressed to store energy due to the blocking of the limiting member 14 on the elastic member 33. During the process of pulling the plug 200 out of the DC socket 100, the elastic member 33 can release energy and drive the moving member 3 to move along the moving direction X and reset.

As described above, the movable attracting member 5 is able to move towards the corresponding fixed attracting member 11 under the action of the attractive force upon being adjacent to the corresponding fixed attracting members 11 of the pair of fixed attracting members 11. The movable attracting member 5 and the fixed attracting member 11 according to implementations of the present disclosure may be various types of attracting members currently known or available in the future, which are not limited by implementations of the present disclosure, as long as they can attract each other.

For example, with continued reference to FIGS. 4 to 6, in some implementations, the fixed attracting member 11 may include a metal member made of a ferromagnetic material, such as iron, nickel, and cobalt. The movable attracting member 5 includes a magnetic body 51 and a pair of magnetic conductive parts 52. The fixed attracting member 11 and the movable attracting member 5 can attract each other through magnetic force. One magnetic conductive part 52 of the pair of magnetic conductive parts 52 may be disposed on a side of the magnetic body 51 adjacent to the top cover 8, and the other magnetic conductive part 52 of the pair of magnetic conductive part 52 may be disposed on a side of the magnetic body 51 facing away from the top cover 8. The magnetic body 51 may be a magnet, and the pair of magnetic conductive parts 52 can be magnetized by the magnetic body 51. With the above configuration, the pair of magnetic conductive parts 52 can be magnetized to opposite magnetism by the magnetic body 51, so as to increase the attracting force between the movable attracting member 5 and the fixed attracting member 11, thereby enabling the moving contact point 21 and the fixed contact point 61 to be separated more rapidly to achieve the purpose of rapid arc extinguishing.

In other implementations, the movable attracting member 5 may include a metal member made of a ferromagnetic material, such as iron, nickel, and cobalt. Correspondingly, the fixed attracting member 11 includes a magnetic body 51 and a pair of magnetic conductive parts 52. As long as the fixed attracting member 11 and the movable attracting member 5 can attract each other through magnetic force.

With continued reference to FIGS. 4 to 6, in some implementations, the moving member 3 may further include a pair of transmission parts 34. The pair of transmission parts 34 are disposed on the side of the first main body 31 adjacent to the top cover 8 at an interval along the moving direction X. The pair of transmission part 34 may be overlapped with the mating groove 312 in the insertion direction Y of the ground pin 202, and the pair of transmission parts 34 is closer to the top cover 8 than the mating groove 312. Correspondingly, the mating member 4 may include a second main body 41. A portion of the second main body 41 is disposed in the mating groove 312 and includes a pair of connecting grooves 411 and a pair of elastic parts 412. As can be seen from FIGS. 4 to 6, the movable attracting member 5 is clamped to the second main body 41 to move synchronously with the mating member 4. In addition, the movable attracting member 5 is further away from the top cover 8 than the pair of elastic parts 412, which facilitates reducing the height of the fixed attracting member 11, thereby reducing costs.

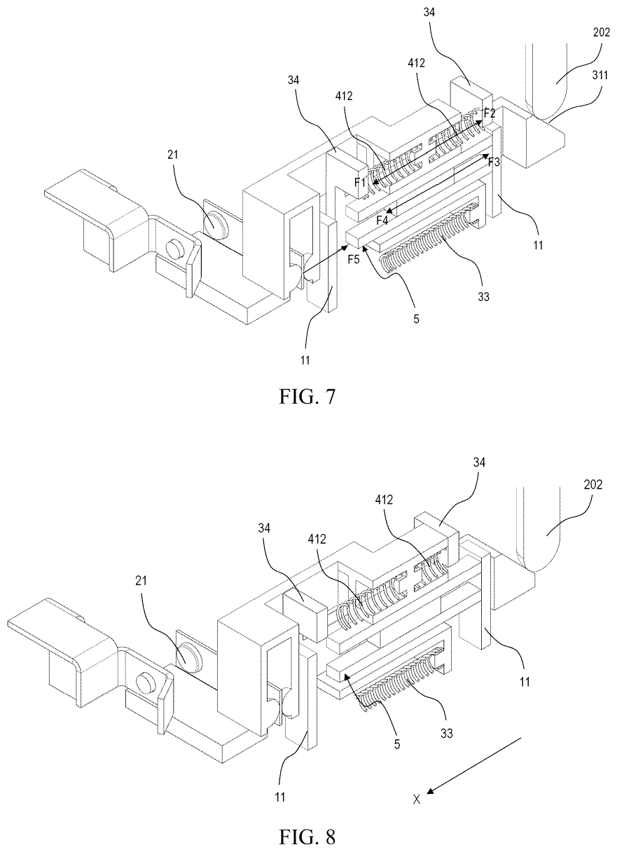

Further, with continued reference to FIG. 4 to FIG. 6, each elastic part 412 of the pair of elastic parts 412 is disposed in the corresponding connecting groove 411, and an end of each elastic part 412 of the pair of elastic parts 412 protruding from the corresponding connecting groove 411 is adapted to abut against the corresponding transmission part 34. That is, the purpose of arranging the pair of transmission parts 34 at an interval is to enable the pair of elastic parts 412 to be located between the pair of transmission parts 34 in the moving direction X. With the above configuration, in a case where the ground pin 202 drives the moving member 3 to move along the moving direction X, since the mating member 4 has not moved yet, the corresponding transmission part 34 can compress the corresponding elastic part 412 to drive the whole of the mating member 4 and the movable attracting member 5 through the elastic force. In implementations of the present disclosure, whether the whole of the mating member 4 and the movable attracting member 5 can move can be determined based on the magnitude of the resultant force of the elastic force of the pair of elastic parts 412 and other forces such as the attracting forces between the movable attracting member 5 and the pair of fixed attracting members 11. The working process of the DC socket 100 will be described hereinafter with reference to FIGS. 7 to 16.

The elastic member 33 and the elastic parts 412 according to implementations of the present disclosure may be various types of elastic members 33 and elastic parts 412 currently known or available in the future, which is not limited by implementations of the present disclosure. For example, in some implementations, the elastic member 33 and the elastic parts 412 may be springs.

With continued reference to FIGS. 4 to 6, in some implementations, the mating member 4 may further include a third main body 42. The third main body 42 may be disposed on a side of the second main body 41 facing away from the driving surface 311 and may include a mounting hole 421. A transmission part 34 of the pair of transmission parts 34 that faces away from the driving surface 311 may be located in the mounting hole 421 and be movable in the mounting hole 421. Thus, the movements of the mating member 4 and the moving member 3 do not interfere with each other.

It should be noted that, since the movable attracting member 5 is located in the moving member 3 and in the mating member 4, and the movable attracting member 5 is located between the pair of fixed attracting members 11, in order to prevent the pair of fixed attracting members 11 from interfering with the movements of the mating member 4 and the moving member 3, with continued reference to FIGS. 4 to 6, in some implementations, a mounting groove 313 is provided on a side of the first main body 31 facing away from the top cover 8. The mounting groove 313 may be in communication with the mating groove 312 and be adjacent to the driving surface 311, and a fixed attracting member 11 of the pair of fixed attracting members 11 that is adjacent to the driving surface 311 may be located in the mounting groove 313 and the mating groove 312. Thus, this fixed attracting member 11 does not interfere with the movement of the moving member 3 while passing through the moving member 3.

Further, a fixed attracting member 11 of the pair of fixed attracting members 11 that faces away from the driving surface 311 may be located in the mounting hole 421. Certainly, in other implementations, as shown in FIG. 6, in a case where the third main body 42 is relatively thin, the fixed attracting member 11 of the pair of fixed attracting members 11 that faces away from the driving surface 311 may not be located in the mounting hole 421, and this fixed attracting member 11 is further away from the top cover 8 than the third main body 42. With the above solution, the fixed attracting member 11 is enabled not to interfere with the movement of the mating member 4.

It should be understood that, in other implementations, the mating member 4 and the moving member 3 may adopt any other appropriate structures to prevent the pair of fixed attracting members 11 from interfering with the movements of the mating member 4 and the movable member 3.

With continued reference to FIGS. 4 to 6, in some implementations, the third main body 42 may further include a clamping hole 422 and a pair of clamping parts 423. The clamping hole 422 and the pair of clamping parts 423 may be located at an end of the third main body 42 facing away from the second main body 41. The pair of clamping parts 423 are disposed in the clamping hole 422 along the moving direction X, and the first connecting member 2 can pass through the clamping hole 422 and be clamped by the pair of clamping parts 423. Thereby, the coupling between the mating member 4 and the first connecting member 2 is achieved. In addition, when the mating member 4 drives the moving contact point 21 on the first connecting member 2 to be in contact with the fixed contact point 61, the mating member 4 can continue to move in a direction towards the fixed contact point 61, and the pair of clamping parts 423 can cause the first connecting member 2 to bend and undergo deformation, thereby enabling the moving contact point 21 to be in tight contact with the fixed contact point 61 and preventing them from separating easily.

FIGS. 7 to 16 show schematic workflow diagrams of the DC socket 100 according to some implementations of the present disclosure.

FIGS. 7 to 12 show an example process of inserting the plug 200 into the DC socket 100.

As shown in FIGS. 5 and 7, when the driving surface 311 is not driven by the ground pin 202, the movable attracting member 5 is attracted by the fixed attracting member 11 on the right side. At this point, the pair of elastic parts 412 are both compressed, and the resultant force of the elastic force of the pair of elastic parts 412 is zero. In this state, the whole of the mating member 4 and the movable attracting member 5 is subjected to the attracting force F3 from the fixed attracting member 11 on the right side and the attracting force F4 from the fixed attracting member 11 on the left side. Although the attractive force F3 is much greater than the attractive force F4 and the elastic member 33 is in a compressed state, the position of the moving member 3 is maintained and cannot move to the right due to the protrusion 32 of the moving member 3 being blocked by the first mounting member 15 shown in FIG. 3.

As shown in FIGS. 7 and 8, when the ground pin 202 starts to be inserted, the drive surface 311 is driven to move, and the moving member 3 moves along the moving direction X by a first distance. It should be noted that the whole of the mating member 4 and the movable attracting member 5 does not move with the moving member 3. Since the elastic part 412 on the left side is separated from the transmission part 34 and is thus not compressed, the whole of the mating member 4 and the movable attracting member 5 is subjected to the elastic force F1 from the elastic part 412 on the right side, the attracting force F3 from the fixed attracting member 11 on the right side, and the attracting force F4 from the fixed attracting member 11 on the left side. In this state, the resultant force is zero and the DC socket 100 is in a critical state. It should be understood that if the ground pin 202 is inserted further, the elastic force F1 will increase and the critical state will be broken.

As shown in FIGS. 7 and 9, upon further insertion of the ground pin 202, the moving member 3 moves along the moving direction X by a second distance, and the whole of the mating member 4 and the movable attracting member 5 can also move along the moving direction X by the second distance, the compression amount of the elastic part 412 on the right side remains unchanged, and the elastic force F1 remains unchanged. In addition, the attractive force F3 decreases while the attractive force F4 increases. At this point, the whole of the mating member 4 and the movable attracting member 5 is subjected to the elastic force F1 from the elastic part 412 on the right side, the attracting force F3 from the fixed attracting member 11 on the right side, the attracting force F4 from the fixed attracting member 11 on the left side, and the reaction force F5 from the first connecting member 2. A direction of the resultant force in this state is the same as the moving direction X. It should be understood that even though the ground pin 202 is not inserted further, the whole of the mating member 4 and the movable attracting member 5 can continue to move along the moving direction X.

As shown in FIGS. 7, 10, and 11, the position of the ground pin 202 is maintained the whole of the mating member 4 and the movable attracting member 5 continues to move along the moving direction X, the compression amount of the elastic part 412 on the right side decreases, and the elastic force F1 decreases. In addition, the attractive force F3 continues to decrease while the attractive force F4 continues to increase. The reaction force F5 arises due to the deformation of the first connecting member 2. The direction of the resultant force in this state is still the same as the moving direction X. It should be understood that, the whole of the mating member 4 and the movable attracting member 5 can continue to move along the moving direction X.

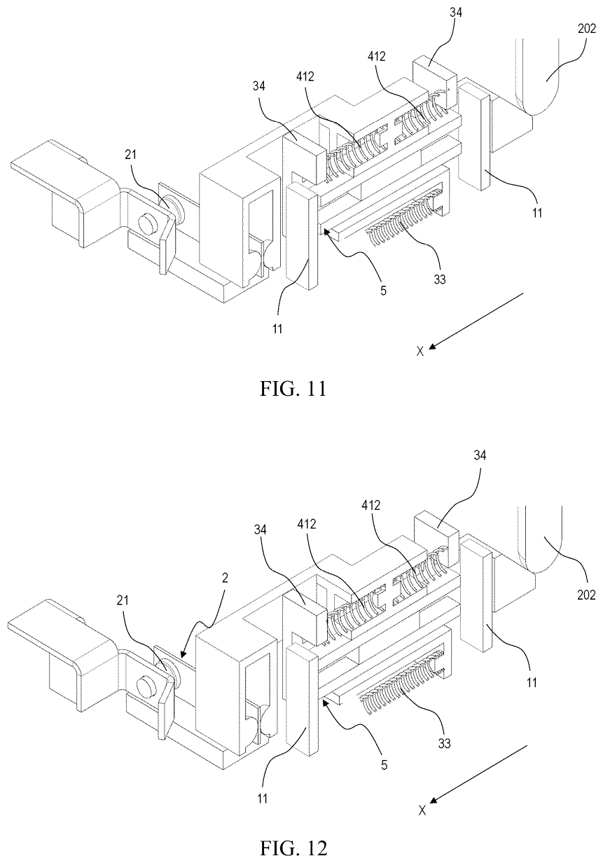

As shown in FIGS. 7 and 12, the position of the ground pin 202 is maintained continuously, the whole of the mating member 4 and the movable attracting member 5 continues to move along the moving direction X until the moving contact point 21 comes into tight contact with the fixed contact point 61, and the movable attracting member 5 is attracted by the fixed attracting member 11 on the left side. The compression amount of the elastic part 412 on the right side decreases, and the elastic force F1 decreases. In addition, the attractive force F3 decreases while the attractive force F4 increases. The reaction force F5 increases due to the deformation amount of the first connecting member 2 increasing. It should be understood that, although the direction of the resultant force in this state is the same as the moving direction X, the whole of the mating member 4 and the movable attracting member 5 is maintained at this position due to the blocking of the fixed contact point 61 and the fixed attracting member 11 on the left side. The fixed contact point 61 is in tight contact with the moving contact point 21.

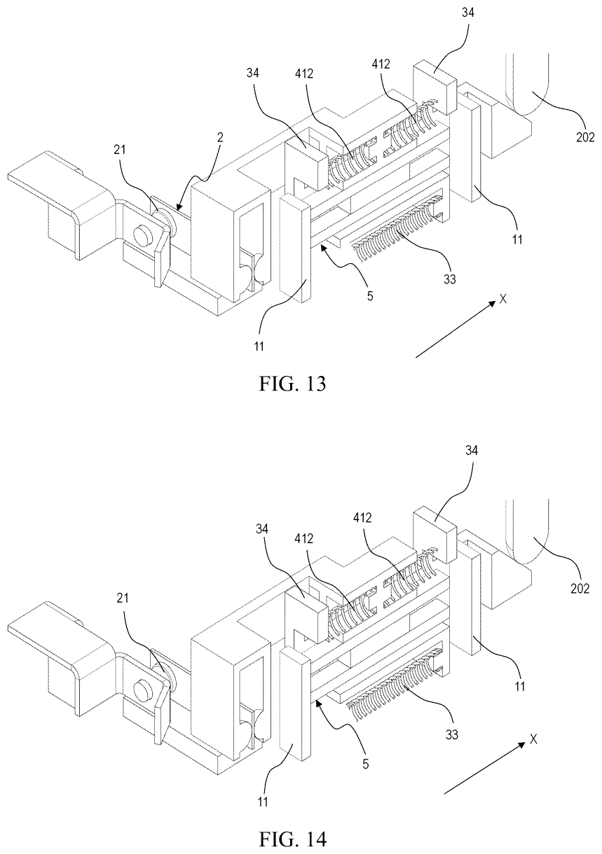

FIGS. 13-16 show an example process of pulling the plug 200 out of the DC socket 100. It can be seen that, since the moving member 3 moves in a reverse direction, the moving direction X in FIGS. 13 to 16 is opposite to the moving direction X in FIGS. 7 to 12. In addition, during the process of inserting the plug 200, the elastic member 33 is subjected to force and is compressed.

As shown in FIGS. 7 and 13, during the process of pulling out the ground pin 202, the moving member 3 moves along the moving direction X by a third distance under the action of the elastic member 33. Since the elastic part 412 on the right side is separated from the transmission part 34 and is thus not compressed, the whole of the mating member 4 and the movable attracting member 5 is subjected to the elastic force F2 from the elastic part 412 on the left side, the attracting force F3 from the fixed attracting member 11 on the right side, the attracting force F4 from the fixed attracting member 11 on the left side, and the reaction force F5 from the first connecting member 2. The resultant force in this state approaches zero and the direction of the resultant force is opposite to the moving direction X. It should be understood that, if the ground pin 202 is pulled out further, the whole of the mating member 4 and the movable attracting member 5 can move along the moving direction X due to the elastic force F2 increasing.

As shown in FIGS. 7 and 14, during the process of pulling out the ground pin 202, the moving member 3 moves along the moving direction X by a fourth distance under the action of the elastic member 33. The elastic force F2 of the elastic part 412 on the left side increases. The direction of the resultant force in this state is the same as the moving direction X, and thus the whole of the mating member 4 and the movable attracting member 5 starts to move along the moving direction X, and the moving contact point 21 starts to be separated from the fixed contact point 61.

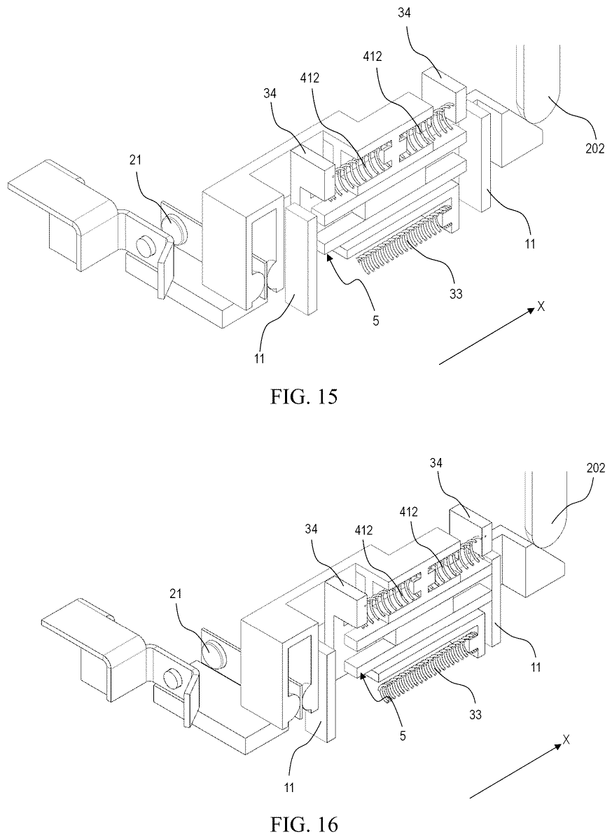

As shown in FIGS. 7 and 15, the position of the ground pin 202 is maintained, the whole of the mating member 4 and the movable attracting member 5 continues to move along the moving direction X to a certain position. At this point, the elastic force F2 is zero. The attractive force F3 increases while the attractive force F4 decreases. The reaction force F5 decreases due to the deformation amount of the first connecting member 2 decreasing. The direction of the resultant force in this state is the same as the moving direction X and the resultant force approaches zero. Thus, the whole of the mating member 4 and the movable attracting member 5 move along the moving direction X by a slight further distance, and then the mating member 4 and the movable attracting member 5 can maintain a stationary state. In other words, the mating member 4 and the movable attracting member 5 are in a stable state.

As shown in FIG. 16, upon the ground pin 202 being pulled out further, the moving member 3 continues to move along the moving direction X under the action of the elastic member 33, and the whole of the mating member 4 and the movable attracting member 5 can return to its initial position.

It should be noted that, with continued reference to FIGS. 14 and 15, during the process of pulling out the ground pin 202, the action of pulling out the plug 200 is continuous, at a moment when the moving contact point 21 and the fixed contact point 61 are about to be separated from each other, upon a distance between the movable attracting member 5 and the corresponding fixed attracting member 11 being reduced to an appropriate distance, the movable attracting member 5 can be attracted by the corresponding fixed attracting member 11. Thus, the movable attracting member 5 and the corresponding fixed attracting member 11 can be rapidly attracted to each other under the action of the attracting force, causing the mating member 4 connected to the movable attracting member 5 to move rapidly and drive the moving contact point 21 on the first connecting member 2 to be quickly disconnected from the fixed contact point 61, thereby rapidly extinguishing the arc.

According to implementations of the present disclosure, during the process of pulling out the plug, the moving member can be released by at least one pin and thus move, and the mating member and the movable attracting member can move towards one fixed attracting member of the pair of fixed attracting members. Upon a distance between the movable attracting member and the fixed attracting member being reduced to an appropriate distance, the movable attracting member can be attracted by the fixed attracting member under the action of attracting force and thus move rapidly, so that the whole of the movable attracting member and the mating member moves rapidly and drives the moving contact point on the first connecting member to be rapidly disconnected from a fixed contact point, thereby achieving the purpose of rapid arc extinguishing.

The design of rapid arc extinguishing according to implementations of the present disclosure can be applied to various DC sockets to at least partially solve the above problems. It should be understood that the design of rapid arc extinguishing according to implementations of the present disclosure may also be applied to other electrical components, which is not limited by implementations of the present disclosure.

Various implementations of the present disclosure have been described above, which are illustrative, not exhaustive, and are not limited to implementations disclosed. Many modifications and variations will be apparent to those of ordinary skill in the art without departing from the scope and spirit of the illustrated implementations. The selection of the terms used herein is intended to explain the principles of the implementations, practical applications, or technical improvements in the marketplace, or to enable others of ordinary skill in the art to understand the implementations disclosed herein.

What is claimed is:

1. A direct current (DC) socket, wherein the DC socket is adapted to mate with a plug and comprises:
a base comprising a receiving groove, and a pair of fixed attracting members and a pair of electrode socket contacts disposed in the receiving groove;
a top cover covering the receiving groove;
a first connecting member disposed in the receiving groove, wherein an end of the first connecting member is electrically connected to one electrode socket contact of the pair of electrode socket contacts, and the other end of the first connecting member is provided with a moving contact point;
a moving member disposed in the receiving groove and adapted to be pressed or released by at least one pin of the plug to move along a moving direction;
a mating member disposed in the receiving groove and movably connected to the moving member, the mating member being adapted to move along the moving direction and coupled to the first connecting member; and
a movable attracting member disposed on the mating member and located between the pair of fixed attracting members in the moving direction, wherein the movable attracting member is adapted to move towards a corresponding fixed attracting member under the action of an attractive force upon being adjacent to the corresponding fixed attracting member of the pair of fixed attracting members.

2. The DC socket of claim 1, wherein the DC socket further comprises a second connecting member and an arc guide member that are disposed in the receiving groove, the second connecting member comprises a fixed contact point mated with the moving contact point, and the arc guide member is disposed adjacent to the moving contact point and the fixed contact point.

3. The DC socket of claim 2, wherein the magnetism of a side of the arc guide member adjacent to the top cover is opposite to the magnetism of a side of the arc guide member facing away from the top cover.

4. The DC socket of claim 1, wherein the moving member comprises a first main body comprising a driving surface, the base further comprises a ground socket contact disposed in the receiving groove, the driving surface is located at a side of the ground socket contact facing away from the top cover and is spaced apart from the ground socket contact, and the driving surface is obliquely arranged relative to an insertion direction of a ground pin of the plug.

5. The DC socket of claim 4, wherein a side of the first main body adjacent to the top cover is provided with a mating groove, and a portion of the mating member is disposed in the mating groove and is adapted to move relative to the mating groove.

6. The DC socket of claim 5, wherein the base comprises a limiting member disposed in the receiving groove, the moving member further comprises a protrusion and an elastic member, the protrusion is disposed on a side of the first main body facing away from the top cover, an end of the elastic member is connected to a side of the protrusion facing away from the driving surface, and the other end of the elastic member is connected to the limiting member.

7. The DC socket of claim 5, wherein the fixed attracting part comprises a metal member, the movable attracting member is located in the mating groove and comprises a magnetic body and a pair of magnetic conductive parts, one magnetic conductive part of the pair of magnetic conductive parts is disposed on a side of the magnetic body adjacent to the top cover, the other magnetic conductive part of the pair of magnetic conductive parts is disposed on a side of the magnetic body facing away from the top cover, and the pair of magnetic conductive parts are adapted to be magnetized by the magnetic body.

8. The DC socket of claim 5, wherein the moving member further comprises a pair of transmission parts arranged on the side of the first main body adjacent to the top cover at an interval along the moving direction, the mating member comprises a second main body, a portion of the second main body is disposed in the mating groove and comprises a pair of connecting grooves and a pair of elastic parts, each elastic part of the pair of elastic parts is disposed in the corresponding connecting groove, and an end of each elastic part of the pair of elastic parts protruding from the corresponding connecting groove is adapted to abut against the corresponding transmission part.

9. The DC socket of claim 8, wherein each elastic part comprises a spring.

10. The DC socket of claim 8, wherein the mating member further comprises a third main body, the third main body is disposed on a side of the second main body facing away from the driving surface and comprises a mounting hole, and a transmission part of the pair of transmission parts that faces away from the driving surface is located in the mounting hole and is movable within the mounting hole.

11. The DC socket of claim 5, wherein a mounting groove is disposed on a side of the first main body facing away from the top cover, the mounting groove is in communication with the mating groove and is adjacent to the driving surface, and a fixed attracting member of the pair of fixed attracting members that is adjacent to the driving surface is located in the mounting groove and the mating groove.

12. The DC socket of claim 10, wherein the third main body comprises a clamping hole and a pair of clamping parts, the pair of clamping parts are disposed in the clamping hole along the moving direction, and the first connecting member passes through the clamping hole and is clamped by the pair of clamping parts.

13. The DC socket of claim 12, wherein the clamping hole and the pair of clamping parts are located at an end of the third main body facing away from the second main body.

14. The DC socket of claim 1, wherein the first connecting member comprises an elastic sheet arranged in a bent shape.
